(19) United States
(12) Patent Application Publication
(10) Pub. No.: US 2004/0247721 A1
(43) Pub. Date: Dec. 9, 2004

(54) Machine for forming containers

(76) Inventors: Primo Finetti, Mirandola (IT); Andrea Bartoli, Reggio Emilia (IT)

Correspondence Address: NIXON & VANDERHYE, PC, 1100 N GLEBE ROAD, 8TH FLOOR, ARLINGTON, VA, 22201-4714, US

(21) Appl. No.: 10/498,375

(22) PCT Filed: Dec. 11, 2002
(86) PCT No.: PCT/IB02/05277

(30) Foreign Application Priority Data
Dec. 11, 2001 (IT) MO2001A000246

(51) Int. Cl. B29C 43/44

(52) U.S. Cl. 425/122; 425/412

(57) ABSTRACT

A machine for forming containers comprises a feed line arranged for indexing a web continuous along an advancing direction, a plurality of operating station arranged along the feed line, the operating station being contiguous to one another and operationally associated to the web for forming at least a continuous strip of containers, and positioning device for adjusting the position of one or more operating, along a positioning direction parallel to the advancing direction of the web.

The present invention concerns a machine for forming containers, in particular a machine for forming one or more continuous strips of containers in heat-weldable and heat-formable plastic material.

In particular, the invention refers to a machine made according to the preamble of the first claim.

In general, in known machines, the half-moulds of an operating station are arranged immediately next to the half-moulds of the adjacent station, substantially without intermediate spaces, and the web's advancing step is in correlation with the length of the half-moulds. At each work cycle (in which the web advances by one step and the opposite half-moulds close over the web and reopen) the couple of half-moulds of each operating station treats a web portion of a length substantially equal to the an advancing step; on this web portion is provided the formation of a plurality of containers, still having a step arrangement. The web's advancing step should preferably be the same as an integer multiple of the containers' distance (where this multiple is the same as the number of containers that are processed at each operating cycle in each operating station), otherwise a fraction of said web portion remains unused because it constitutes reject material, which, although being part of the strip, is not actually part of the containers.

Therefore, in the known machines for forming a strip of containers, the operating stations, which are designed to operate according to a preset advancing step, are suitable for forming containers distributed with a reciprocal distance that is equal, or very slightly less, than an integer fraction of the preset advancing step, in order to minimise the waste of material.

One of the problems of the known machines is the adaptation to the format change of the containers (particularly if the format change involves an important modification to the distance between adjacent containers) without creating reject material. An object of the present invention is to improve the machines for forming containers.

An advantage of the invention is that it makes available a machine that adapts simply and rapidly to containers' format changes.

Another advantage is to obtain a machine that allows minimising the formation of reject material during the format change of the containers to be obtained, especially in the case of modification of the distance of the containers along the strip.

A further advantage is to obtain a reliable and accurate machine that is constructionally simple and cheap.

According to the invention, is provided a machine as defined by the claim 1.

The operating stations that work on the web can be positioned in the indexing direction of the web.

It may be possible that one of the stations, which acts as reference station, could not be positioned.

This reference station should preferably be an end station, preferably the station arranged as the last one.

The control for positioning the different operating stations should preferably be centralised.

It is furthermore preferable that the positioning of all the operating stations is controlled by a single actuating system and that the shift of each station is adjustable in relation to the shift of all the other stations.

It is preferable to arrange a centralised positioning system for positioning the operating stations, by virtue of which the amount of the shift of each station is in a preset relation to the amount of the shifts of all the other stations.

It is preferable that the shifts of the different stations should be adjusted in such a way that, after the positioning of the stations, it is possible to replace the half-moulds with new half-moulds (purposely prepared to obtain containers with a different format), these new half-moulds are arranged very close each others, one immediately next to the other, substantially without an intermediate space between them.

Further features and advantages of the present invention will better appear from the following detailed description of an embodiment of the invention in subject, illustrated, by way of example and not of limitation, in the accompanying Figures.

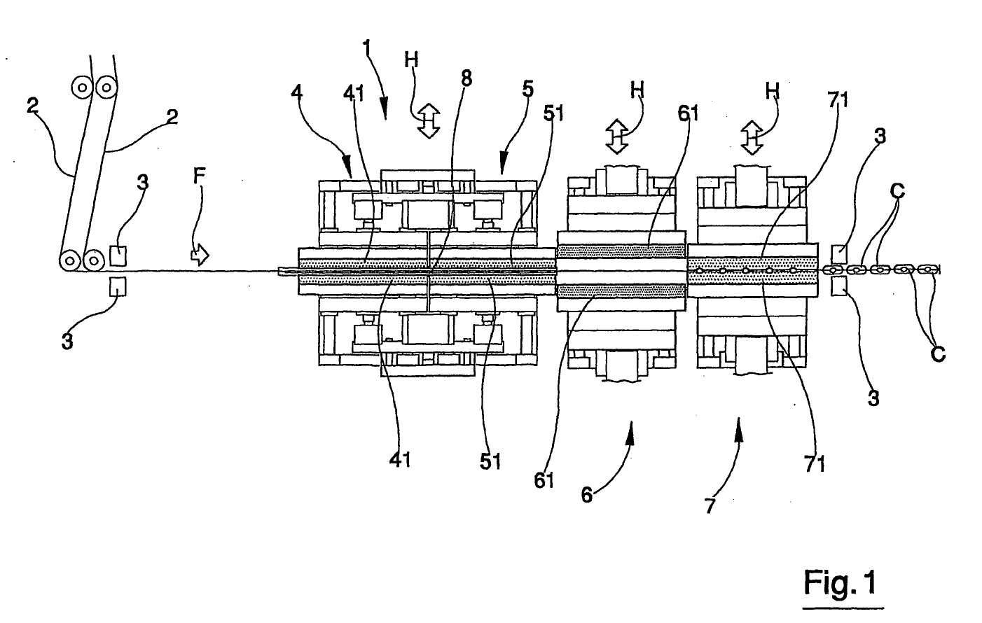

FIG. 1 shows a top plan view of a part of the forming machine in subject.

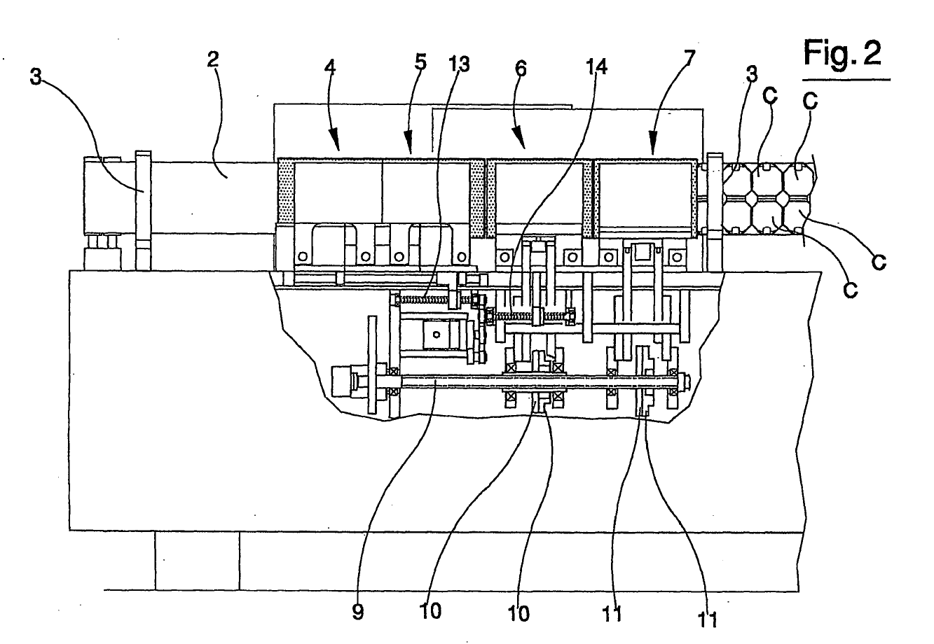

FIG. 2 shows a side view of FIG. 1 with certain parts removed to better show the others.

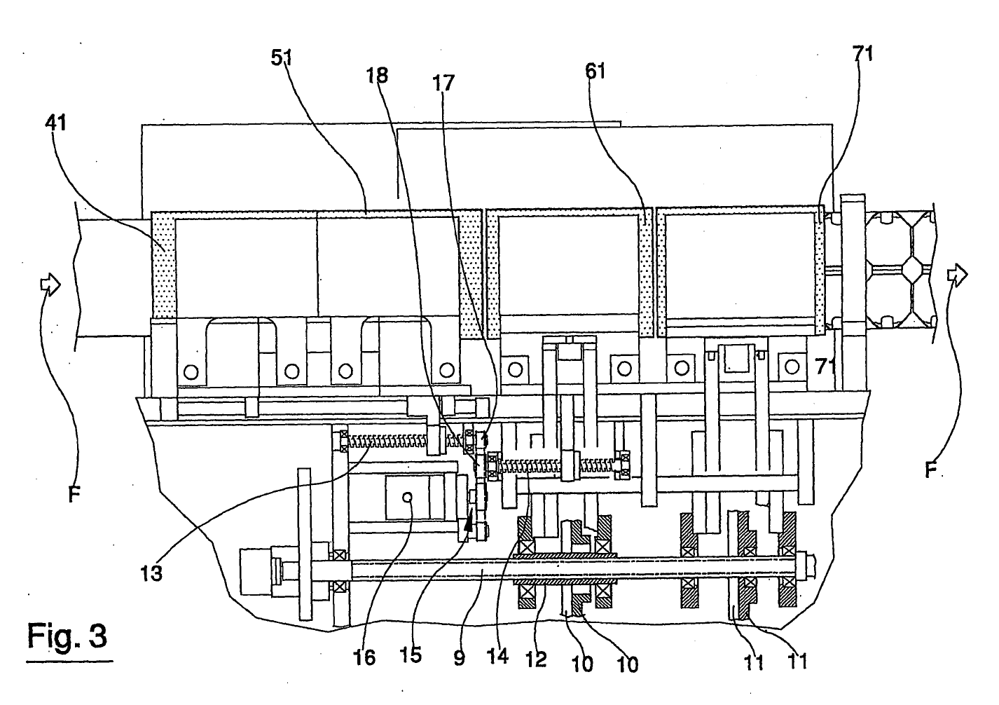

FIG. 3 shows an enlarged detail of FIG. 2.

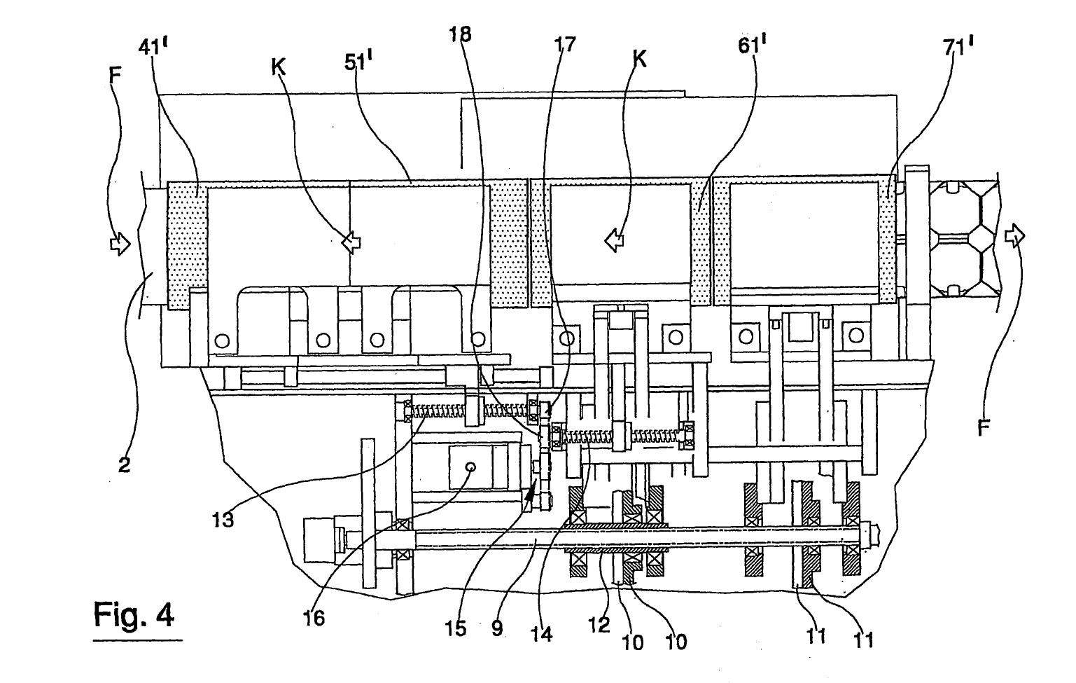

FIG. 4 shows the detail of FIG. 3 in a different operating configuration.

With reference to the above-cited Figures, is shown a machine 1 for forming a continuous strip of containers arranged in succession one after the other.

The machine 1 comprises a feed line, along an advancing direction F, of at least two continuous webs 2 of material, each one of which in form of a relatively thin film, which advance facing one another. The two continuous webs could be made from a single continuous strip longitudinally folded in the shape of a V. The material of the webs 2 is preferably a heat-weldable and heat-formable plastic material. Each web 2 is unwound from a respective reel (not shown). The webs 2 index intermittently in direction F at a preset advancing step, dragged by known movement means that are formed, for example, by pairs of jaws 3 that can be moved back and forth and that are arranged for tighten the webs 2 during the forth motion and to release them during the return motion.

The advancing step of the webs 2 is adjustable: the step adjustment means is known and not shown: it may, for example, comprise a motion transmission mechanism that transmits the motion between a rotation shaft and the pair of jaws 3 and that, in turn, comprises one or more elements which are articulated by means of at least one trunnion, the position of which is adjustable, for example along a slot, so as to vary at will the reciprocal distance between two trunnions of the mechanism, and consequently to vary the stroke of the jaws 3. The machine 1 comprises a plurality of operating stations, contiguous to one another and arranged along the feed line, which arranged for transforming the two webs 2 into a continuous strip of containers C. In the case in point the operating stations are, in succession, two pre-heating stations 4 and 5 for pre-heating the webs, a welding station 6 and a forming station 7. The length of each operating station, measured along the advancing direction F of the webs, is almost the same as the advancing step of these webs. The different stations 4, 5, 6, 7 are arranged one immediately in succession after the other. Each operating station comprises a pair of half-moulds 41, 51, 61, 71 opposite each other, between which the passage of the webs is provided. The half-moulds 41, 51, 61, 71 can easily be removed and replaced with other half-moulds, in the event of format change of the containers to be obtained.

Each pair of half-moulds 41, 51, 61, 71, in each operating station, can be operated to move between a first closing position, in which the half-moulds operate on the webs 2 (preferably in contact with the webs), and a second opening position, in which they are removed from the webs.

The approaching and removing movement, in direction H, should preferably be horizontal and orthogonal in relation to the preferably horizontal advancing direction F of the webs 2.

In FIG. 1, solely by way of example, is shown the forming station 7 with the half-moulds 71 closed, i.e. when they are near the webs and operate on the webs 2 to define the forming cavities, whilst the pre-heating stations 4 and 5 and the welding station 6 are shown with the half-moulds 41, 51 and 61 open, i.e. far from the webs 2.

In the pre-heating stations 4 and 5, is arranged, between the webs 2, a separating wall 8 for preventing the reciprocal contact and the direct heat transmission between the webs during the pre-heating.

In the welding station 6 the webs 2 are heat-welded in preset welding zones so as to define alveoli, each of which has at least one opening.

In the forming station 7 the two half-moulds 71 opposite to each another, once they are drawn up to the closing position, originate forming cavities in which the containers are heat-formed by blowing a forming fluid that is injected inside the alveoli, by means of nozzles, through said openings. The injection of the forming fluid causes the expansion of the alveoli inside the forming cavities. The blowing means for blowing the forming fluid (usually compressed air) is known and not shown.

The operating means for opening and closing the half-moulds 41, 51, 61 and 71 is known and it is partially and schematically shown. The two pairs of pre-heating half-moulds 41 and 51 are movable in direction H, said pre-heating half-moulds 41 and 51 being rigidly connected, operated by, for example, fluidic axial actuators. The welding half-moulds 61 and the forming half-moulds 71, operate in the closing position, in contact with the webs at an operating pressure that is greater than that of the pre-heating half-moulds 41 and 51, and they are actuated for opening ad closing by a drive unit comprising a rotation shaft 9 that make to rotate, for each pair of half-moulds, one or more rotating control members (in the case in point cams 10 and 11, respectively) which are in turn connected, by means of a known motion transmission mechanism not shown, to the half-moulds 61 and 71 to actuate them in a coordinated manner for opening and closing.

The position of the pre-heating stations 4 and 5, and of the welding station 6 can be adjusted along a positioning direction that is parallel to the advancing direction F of the web. The two pre-heating stations 4 and 5 form a single group of stations that is movable in the positioning direction by means of a coupling, the coupling is slidable on an axial guide that is parallel to said positioning direction; the group of the pre-heating stations 4 and 5 that can be positioned along the guide, comprises both the pre-heating half-moulds 41 and 51, and the operating means (fluid-actuated) for operating opening and closing of the half-moulds in direction H.

Also the welding station 6, which comprises both the welding half-moulds 61 and the operating means for actuating the opening and closing movement of the half-moulds in direction H, is movable on a guide that is parallel to the positioning direction; it is substantially preferable that even the operating means for operating opening and closing of the half-moulds (except for the shaft 9 that make the cams 10 to rotate) can carry out the positioning movement on the guide integrally with the welding half-moulds 61.

The cams 10 that actuate the welding half-moulds 61 are connected to the rotation shaft 9 by means of the interposing of a support element 12 that is in turn connected to the shaft 9 with a known coupling that makes it integral in rotation, but axially slidable in relation to the shaft.

The machine comprises a positioning device arranged for carrying out a controlled shift of said operating stations (pre-heating 4 and 5 and welding 6) in the positioning direction so that the amount of the shifts of each station is in a predetermined relation to the amount of the shift of the other stations. In particular, the positioning device is arranged for shift the two stations, rigidly connected to each other, which are located before all the others, i.e. the two pre-heating stations 4 and 5, by a preset amount in a preset ratio with respect to the shift of the subsequent welding station 6 (said amounts and their ratio depend on the advancing step that you wish to obtain—and therefore they depend on the length of the operating stations—as well as on the condition of maintaining the reciprocal contiguousness of the different stations).

The positioning device comprises two manoeuvring screws 13 and 14, one of which is arranged for operating the positioning movement of the two pre-heating stations 4 and 5, and the other one is arranged for operating the shift of the welding station 6.

The positioning device further comprises a motion transmission mechanism arranged for transmitting the motion from a single actuating member to both the manoeuvring screws 13 and 14, according to the transmission ratio that is preset and characteristic of each station or of each group of stations.

The actuating member substantially operates the positioning movement of all said positionable stations.

The actuating member comprises a rotating element 15, whose rotation can be externally operated, (for example by means of a crank that can be movably inserted in a connection point 16) and also a wheel coupled, for example by means of a flexible motion transmission member, with two wheels 17 and 18, each one of the wheels is associated with a relative manoeuvring screw 13 and 14. To obtain the required ratio between the amount of the positioning shifts of the pre-heating stations 4 and 5 and, respectively, of the welding station 6, wheels 17 and 18 can be used with different diameters in an appropriate transmission ratio (as in the illustrated example), or manoeuvring screws 13 and 14 can be used with different step in an appropriate ratio, or other known devices that achieve the aim of carrying out controlled shifts of the different stations according to a preset ratio, can be used.

In the operation, when it is necessary to carry out a format change, passing, for example, from half-moulds of a preset size, to half-moulds of lower size, the positioning device allows to shift the stations, one in relation to the other, so as to position the half-moulds of a station in such way as they results to be contiguous to the half-moulds of the adjacent station.

The positioning device allows, in fact, drawing up the half-mould of subsequent stations of a distance equal to the sum of the differences between the sizes of the half-mould that has been replaced and the sizes of the half-mould that has been subsequently installed.

In order to compensate possible dimensional variations, due for example to shrinkages or to thermal expansions of the material to be formed, it is possible to operate the positioning device so as to obtain a fine regulation.

Likewise, dimensional variations due to the thermal expansion of the half-moulds can be compensated.

In practice, in order to compensate a material's shrinkage, the welding half-moulds are drawn up to the forming moulds for a distance corresponding to the above said shrinkage.

A regulation like that can be precluded by the fact that the ends of the welding half-moulds contact the respective ends of the forming half-moulds thus avoiding a further approaching.

In order to solve this inconvenience, are used forming and/or welding half-moulds with lower sizes in relation to the expected nominal sizes.

In particular, during the production of the forming half-moulds and of the welding half-moulds, which have to be in operation reciprocally adjacent, a portion of material constituting these half-moulds is removed in correspondence to their ends.

Therefore, half-moulds are obtained which are mounted asymmetrically on their respective stations.

The support element 12 (element that, as previously mentioned, is interposed between the actuating cams 10 of the welding half-moulds 61 and the rotating shaft 9—with rotation axis that is parallel to the positioning direction—said support element 12 makes the cams to rotate, and is rotated by the shaft 9 but it is axially movable on the shaft itself) is connected with the positioning device by means of one or more rolling supports and can be axially shifted on the shaft, in both ways along the positioning direction by said device, with subsequent shift of the cams 10 rigidly connected therewith. Substantially, the entire welding station 6 (in particular, from the support element 12, fitted with sliding coupling on the control shaft of the cams, including the cams 10, up to at least the half-moulds 61 that carry out the heat-welding of the webs) can be guided by the manoeuvring screw 14 to carry out positioning movements in both ways.

The last station (in the case in point the forming station 7) can be fixed, performing the reference function for the positioning of the other stations. Downstream of the last station, it is possible to arrange, along the feed line of the strip of containers, one or more different operating stations (for example a filling station of the containers, a sealing station of the containers, a station for cooling the filling material, a station for shearing the strip into sections, etc). These further operating stations (known and not shown) are spaced, i.e. they are not contiguous, in respect to the last operating station (forming station) described above.

The first one of the mutually contiguous operating stations (in the case in point the pre-heating station 4) can be rigidly connected, as regards the positioning movement, with the second operating station immediately adjacent to it (in the case in point the pre-heating station 5). The group consisting of the two pre-heating stations 4 and 5 can then be guided by the manoeuvring screw 13 to perform positioning movements (in both ways) of a controlled amount in such a way that the shift of the group is in a preset relation to the shift of the adjacent welding station 6. The absolute value of the amount of said shifts depends on the advancing step that one wishes to obtain, which in turn depends on the distance of the containers arranged on the strip to be formed (as mentioned, the advancing step of the strip should preferably be an integer multiple of the distance of the containers), and the advancing step is selected in such a way that, after positioning, and after replacing of the half-moulds in the operating stations (half-moulds which are of a length that is almost the same as the new advancing step of the strip, and which are suitable for operating according to the new distance of the containers), the contiguity condition of the different stations is still maintained, so that the new half-moulds are still arranged one immediately after another. FIGS. 3 and 4 show the different operating stations in two configurations: in the first configuration (FIG. 3) the half-moulds 41, 51, 61 and 71 (and therefore also the strip's advancing step) are shorter than those in the second configuration (FIG. 4), in which the pre-heating and the welding stations have been shifted (in this case, with reference to FIG. 4, to the left, as indicated by the arrows K), and the relative old half-moulds 41, 51, 61 and 71 have been replaced with longer new half-moulds 41′, 51′, 61′ and 71′ that are still arranged contiguously to one another.

In other embodiments that are not shown, it may be provided that the reciprocally contiguous operating stations are arranged in a different order (for example with the forming station arranged before the welding station), or that the operating stations are of different kind (for example, it is possible to provide a different number or the absence of the pre-heating stations; forming can also occur by means of aspiration rather than blowing; etc).

Numerous practical applicative modifications of constructional details can be applied to the invention without leaving the scope of the inventive idea claimed below.

1-11. (canceled).

12. Machine for forming containers comprising a feed line arranged for indexing at least a web continuous, along an advancing direction, a plurality of operating stations arranged along said feed line and operationally associated with the web for forming at least one continuous strip of containers, wherein it further comprises positioning device to adjust the position of one or more operating stations of said plurality of operating stations along a positioning direction that is parallel to said advancing direction.

13. Machine according to claim 1, and further comprising adjusting device arranged for adjusting the advancing step of said web.

14. Machine according to claim 1, or 2, wherein said positioning device is arranged for shifting in a controlled manner two or more operating stations, or groups of operating stations, in the positioning direction, preferably simultaneously, in such a way that the amount of the shifts of each station is in a preset relation to the amount of the shifts of the other stations.

15. Machine according to claim 1 or 2, wherein said positioning device comprises at least one manoeuvring screw arranged for operating the positioning movement of the operating station.

16. Machine according to claim 1 or 2, wherein said one or more operating stations are positionable, said operating stations being connected, by means of a motion transmission mechanism and according to a preset transmission ratio, to an actuating member that controls the positioning of said one or more stations.

17. Machine according to the claim 1, wherein each operating station comprises actuating arrangement to operate the opening and closing movement of the operating elements, said actuating arrangement comprising, for at least one of said operating stations, a drive unit operationally associated with the operating elements, or half-moulds, of said station and equipped with at least one rotating command member that is arranged for receiving the rotation motion from a rotation shaft with an axis parallel to the positioning direction of the station and which is furthermore arranged for controlling the opening and closing movement of the operating elements, the rotating command member being axially movable in relation to said shaft to follow the positioning movement of the operating station.

18. Machine according to claim 6, and further comprising at least one welding station and at least one forming station, at least one of these stations being provided with the drive unit according to claim 6.

19. Machine according to claim 1 or 2, wherein at least one operating station is fixed to perform the reference function for the positioning of the other stations and said fixed reference operating station can be arranged as the last station downstream of the positionable operating stations.

20. Machine according to claim 8, and further comprising one or more operating stations arranged along said feed line, downstream of said fixed reference operating station, to perform certain operations, such as filling or sealing, on the formed containers.

21. Machine according to claim 8, and further comprising one or more pre-heating stations of two webs that face each other, at least one welding station in which the webs are welded to form one or more alveoli, at least one forming station in which the alveolus is expanded within a forming cavity to form a container, the pre-heating stations and the welding station being adjustable in position, the device for adjusting positioning of the operating stations being arranged for operating the shifts of both the pre-heating stations and the welding station, in such a way that the amount of the positioning shifts of the first ones is in a preset relation to the size of the shifts of the second one.

22. Machine according to claim 1, wherein in each station is provided a pair of operating elements opposite each others, among which the passage of the web is provided, said operating elements are removable and openable and closable in relation to the web.

23. Machine for forming containers comprising a feed line arranged for indexing at least a web continuous, along an advancing direction, a plurality of operating stations arranged along said feed line and operationally associated with the web for forming at least one continuous strip of containers, positioning device to adjust the position of one or more operating stations of said plurality of operating stations along a positioning direction that is parallel to said advancing direction, adjusting device arranged for adjusting the advancing step of said web, wherein said positioning device is arranged for shifting in a controlled manner two or more operating stations, or groups of operating stations, in the positioning direction, preferably simultaneously, in such a way that the amount of the shifts of each station is in a preset relation to the amount of the shifts of the other stations.

24. Machine according to claim 12, wherein said positioning device comprises at least one manoeuvring screw arranged for operating the positioning movement of the operating station.

25. Machine according to claim 12 or 13, wherein said one or more operating stations are positionable, said operating stations being connected, by means of a motion transmission mechanism and according to a preset transmission ratio, to an actuating member that controls the positioning of said one or more stations.

26. Machine according to claim 12 or 13, wherein at least one operating station is fixed to perform the reference function for the positioning of the other stations and said fixed reference operating station can be arranged as the last station downstream of the positionable operating stations.

27. Machine according to claim 14, wherein at least one operating station is fixed to perform the reference function for the positioning of the other stations and said fixed reference operating station can be arranged as the last station downstream of the positionable operating stations.
